(19) United States
(12) Patent Application Publication
(10) Pub. No.: US 2009/0295969 A1
(43) Pub. Date: Dec. 3, 2009

(54) SOLID-STATE IMAGING APPARATUS

(75) Inventor: Toru KONDO, Hino-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/476,616

(22) Filed: Jun. 2, 2009

(30) Foreign Application Priority Data
Jun. 3, 2008 (JP) 2008-145582

(51) Int. Cl. H04N 5/335

(52) U.S. Cl. 348/308; 348/E05.091

(57) ABSTRACT

A solid-state imaging apparatus, comprising, a pixel section including a two-dimensional matrix of a plurality of pixels each provided with a photoelectric conversion section, and an amplifier section that amplifies an output of the photoelectric conversion section and outputs a pixel signal, a column signal line provided on a column basis in the pixel section to receive the pixel signal outputted from the amplification section of each of the pixels, a column amplification section in which a first input terminal is coupled with an end of each of the column signal lines via a first switch device, and a second input terminal is coupled via a second switch device with a load section that is in charge of setting an amplification rate for use to amplify the pixel signal, a third switch device that couples together the load section and others in the plurality of various columns, and a control section that controls coupling and decoupling by the first, second, and third switch devices.

### This application claims benefit of Japanese Patent Application No 2008-145582 filed in Japan on Jun. 3, 2008, the contents of which are incorporated by this reference.

### BACKGROUND OF THE INVENTION

The present invention relates to a solid-state imaging apparatus that uses a solid-state imaging device including an amplification section on a column basis, and a camera system.

In an imaging apparatus such as digital still camera that outputs an image signal through conversion of light into an electric signal, a MOS (Metal-Oxide Semiconductor) type image sensor has been recently used as a solid-state imaging apparatus for use as an imaging device thereof. The MOS-type imaging sensor has been actively under research and development.

Patent Document 1 (JP-P2003-51989A) describes a previous MOS-type image sensor, for example, and FIG. 1 shows an exemplary configuration of a pixel signal read circuit in the MOS-type image sensor This MOS-type image sensor is configured to include pixels 11, 12, 21, and 22, a vertical scanning section 2, vertical signal lines 3-1 and 3-2, bias transistors M5, column amplification sections 4-1 and 4-2, noise suppression sections 5-1 and 5-2, column-selection transistors M10 and M11, a horizontal scanning section 6, horizontal signal lines 7-1 and 7-2, an output amplifier 8, and a timing control section 9. The pixels 11, 12, 21, and 22 are arranged in a matrix (2-by-2 matrix in FIG. 1 example), and the vertical scanning section 2 serves to provide read pulses to the pixels 11, 12, 21, and 22. The vertical signal lines 3-1 and 3-2 are provided for transmitting signals outputted from the pixels 11, 12, 21, and 22, and the bias transistors M5 provide a constant current to the vertical signal lines 3-1 and 3-2, respectively. The column amplification sections 4-1 and 4-2 are provided for amplifying the potentials of the vertical signal lines 3-1 and 3-2, respectively. The noise suppression sections 5-1 and 5-2 are those for eliminating any noise included in the outputs from the column amplification sections 4-1 and 4-2, respectively. The column-selection transistors M10 and M11 are those for outputting signals selectively to the horizontal signal lines 7-1 and 7-2 from the noise suppression sections 5-1 and 5-2. The horizontal scanning section 6 serves to provide pulses to each of the column-selection transistors M10 and M11 The output amplifier 8 is for amplifying, before output, signals from the horizontal signal lines 7-1 and 7-2. The timing control section 9 provides a control signal to each of the components, i.e., the vertical scanning section 2, the column amplification sections 4-1 and 4-2, the noise suppression sections 5-1 and 5-2, and the horizontal scanning section 6.

The pixels 11, 12, 21, and 22 are each configured to include a photodiode PD, a transfer transistor M1, an amplification transistor M3, a reset transistor M2, and a row-selection transistor M4. The photodiode PD serves to convert an incident light into an electric signal The transfer transistor M1 is provided for transferring the electric signal accumulated in the photodiode PD, and the amplification transistor M3 is for amplifying the electric signal provided through transfer. The reset transistor M2 is for resetting the potential of a gate electrode of the amplification transistor M3 or others, and the row-selection transistor M4 is for selectively outputting an amplified signal being the amplification result of the electric signal The gates of these transistors, i.e., the transfer transistor M1, the reset transistor M2, and the row-selection transistor M4, are respectively provided with various pulses from the vertical scanning section 2 on a row basis Such pulses include transfer pulses φTX1 and φTX2, reset pulses φRST1 and φRST2, and row-selection pulses φROW1 and φROW2. The drains of the transistors, i.e., the reset transistor M2, and the amplification transistor M3, are each coupled with a pixel power supply VDD.

The column amplification sections 4-1 and 4-2 are each configured to include a gain amplifier AMP, a clamp capacity Cc, a clamp transistor M6, a feedback capacity Cf, an amplifier reset transistor M7, and an amplifier capacity Cg. The gain amplifier AMP is provided for amplifying the signals outputted from the corresponding pixels 11 and 21, or 12 and 22 The clamp capacity Cc is coupled between a non-inverting input terminal of the gain amplifier AMP and the corresponding vertical signal line 3-1 or 3-2 to clamp the outputs from the corresponding pixels 11 and 21, or 12 and 22 at a clamp potential VC. The clamp transistor M6 serves to supply the clamp potential VC to the non-inverting input terminal of the gain amplifier AMP. The feedback capacity Cf and the amplifier reset transistor M7 are those coupled between the inverting input terminal and an output terminal of the gain amplifier AMP. The amplifier capacitor Cg is coupled between the inverting input terminal of the gain amplifier AMP and the ground potential. The gates of the transistors, i.e., the clamp transistor M6, and the amplifier reset transistor M7, are each so designed as to receive a clamp pulse φCL1.

The noise suppression sections 5-1 and 5-2 are each configured to include a reset sample capacitor Cn, a reset sample transistor M9, a signal sample capacitor Cs, and a signal sample transistor M8. The reset sample capacitor Cn holds the reset potential from the corresponding column amplification section 4-1 or 4-2. The reset sample transistor M9 establishes a coupling between the output from the corresponding column amplification section 4-1 or 4-2 and the reset sample capacitor Cn. The signal sample capacitor Cs holds the signal potential from the corresponding column amplification section 4-1 or 4-2. The signal sample transistor M8 establishes a coupling between the output from the corresponding column amplification section 4-1 or 4-2 and the signal sample capacitor Cs. The gate of the signal sample transistor M8 is so designed as to receive a signal sample pulse φHS, and the gate of the reset sample transistor M9 is so designed as to receive a reset sample pulse φHN.

FIG. 2 is a timing chart for illustrating the operation of the previous MOS-type image sensor of FIG. 1. First of all, the vertical scanning section 2 enables the read operation of the pixels 11 and 12 in the first row, and the row-selection pulse φROW1 is set to the H (High) level so that the row-selection transistors M4 are changed their states to ON The outputs of the amplification transistors M3 are then respectively read to the vertical signal lines 3-1 and 3-2. The reset pulse φRST1 is then set to the H level so that the reset transistors M2 are changed their states to ON. This accordingly resets the gates of the amplification transistors M3 at the reset potential, and the outputs of the pixels 11 and 12 related to the reset potential are respectively read to the vertical signal lines 3-1 and 3-2. At this time, the clamp pulse φCL1 is set to the H level, and the amplification reset transistors M7 of the column amplification sections 4-1 and 4-2 are both changed their states to ON, thereby resetting the column amplification sections 4-1 and 4-2. At the same time, the clamp transistors M6 are changed their states to ON, and the non-inverting input terminal of each of the gain amplifiers AMP is clamped at the clamp potential VC.

Next, after the reset pulse φRST1 is set to the L (Low) level, the clamp pulse φCL1 is set to the L level, and this is the end of the clamping. Thereafter, the reset pulse φRST1 is set to the L level, and the reset sample pulse φHN is set to the H level, thereby reading the reset signals of the column amplification sections 4-1 and 4-2 to their each reset sample capacitor Cn The reset sample pulse φHN is then set to the L level, thereby maintaining the reset signals. Next, the transfer pulse φTX1 is set to the H level, and the transfer transistors M1 are changed their states to ON, thereby transferring an electric signal being the conversion result of an optical signal generated in the photodiode PD to the gates of the amplification transistors M3 The vertical signal lines 3-1 and 3-2 are each provided with a signal being the amplification result of the electric signal, which is the conversion result of the optical signal. Then in the gain amplifiers AMP of the column amplification sections 4-1 and 4-2, their non-inverting input terminals respectively show changes of ΔSig1 and ΔSig2 by the clamp capacitor Cc from the reset potential values of the pixels 11 and 12 due to the electric signal being the conversion result of the optical signal. At this time, the outputs of the column amplification sections 4-1 and 4-2 show changes of (1+Cg/Cf) ΔSig1, and (1+Cg/Cf)ΔSig2 with respect to the reset signals of the column amplification sections 4-1 and 4-2, respectively Next, after the transfer pulse φTX1 is set to the L level, the signal sample pulse φHS is set to the H level, thereby reading the read signals from the column amplification sections 4-1 and 4-2 to the signal sample capacitiors Cs, respectively. The signal sample pulse φHS is then set to the L level, and thereby the read signals are held in the signal sample capacitiors Cs.

Lastly, the signals maintained in the signal sample capacities Cs and the reset sample capacities Cn are read respectively to the horizontal signal lines 7-1 and 7-2 in a sequential manner by the horizontal scanning section 6, and the read results are differentiated by the output amplifier 8 for output. The reset signals and the read signals of the column amplification sections 4-1 and 4-2 each include offset noise caused by the column amplification sections 4-1 and 4-2. However, the differential operation by the output amplifier 8 enables to extract only the electric signal ΔSig being the conversion result of the optical signal generated in the photodiode PD. Moreover, the electric signal ΔSig is multiplied by (1+Cg/Cf) in each of the column amplification sections 4-1 and 4-2, thereby being able to reduce any noise possibly caused by the components subsequent to the column amplification sections 4-1 and 4-2.

In such a previous MOS-type image sensor, the amplification rate is determined through adjustment of the capacity ratio (Cg/Cf). The amplification rate is preferably low when an optical signal generated in the photodiode PD is high in level, and is preferably high when the optical signal generated in the photodiode PD is low in level.

### SUMMARY OF THE INVENTION

A first aspect of the invention is directed to a solid-state imaging apparatus, including a pixel section including a two-dimensional matrix of a plurality of pixels each provided with a photoelectric conversion section, and an amplifier section that amplifies an output of the photoelectric conversion section and outputs a pixel signal, a column signal line provided on a column basis in the pixel section to receive the pixel signal outputted from the amplification section of each of the pixels, a column amplification section in which a first input terminal is coupled with an end of each of the column signal lines via a first switch device, and a second input terminal is coupled via a second switch device with a load section that is in charge of setting an amplification rate for use to amplify the pixel signal, a third switch device that couples together the load section and others in the plurality of various columns, and a control section that controls coupling and decoupling by the first, second, and third switch devices.

According to a second aspect of the invention, in the solid-state imaging apparatus of the first aspect, the control section couples together the load sections in the plurality of various columns by the third switch device, and with respect to the plurality of various columns coupled together, alternately one by one, performs the coupling between the first and second switch devices in the column amplification section for any of the columns being a pixel signal acquisition target, and the decoupling between the first and second switch devices in the column amplification section for any of the columns being not the pixel signal acquisition target.

According to a third aspect of the invention, in the solid-state imaging apparatus of the first or second aspect, the load section is a capacitor or a resistor.

A fourth aspect of the invention is directed to a camera system, including- the solid-state imaging apparatus of any of the first to third aspects, and an input section provided to the control section of the solid-state imaging apparatus for setting of a control operation in accordance with imaging requirements.

### BRIEF DESCRIPTION OF THE DRAWINGS

FIG. 1 is a diagram showing the circuit configuration example of a previous solid-state imaging apparatus, showing a part thereof by blocks, FIG. 2 is a timing chart for explaining the operation of the previous example shown in FIG. 1,

FIG. 3 is a diagram showing the circuit configuration of a solid-state imaging apparatus of a first embodiment of the invention, showing a part thereof by blocks,

FIGS. 4A and 4B are each a timing chart for explaining the operation in the first embodiment shown in FIG. 3,

FIG. 5 is a diagram showing the circuit configuration of a solid-state imaging apparatus of a second embodiment of the invention, showing a part thereof by blocks, and

FIGS. 6A and 6B are each a timing chart for illustrating the operation of the apparatus of FIG. 5 in the second embodiment.

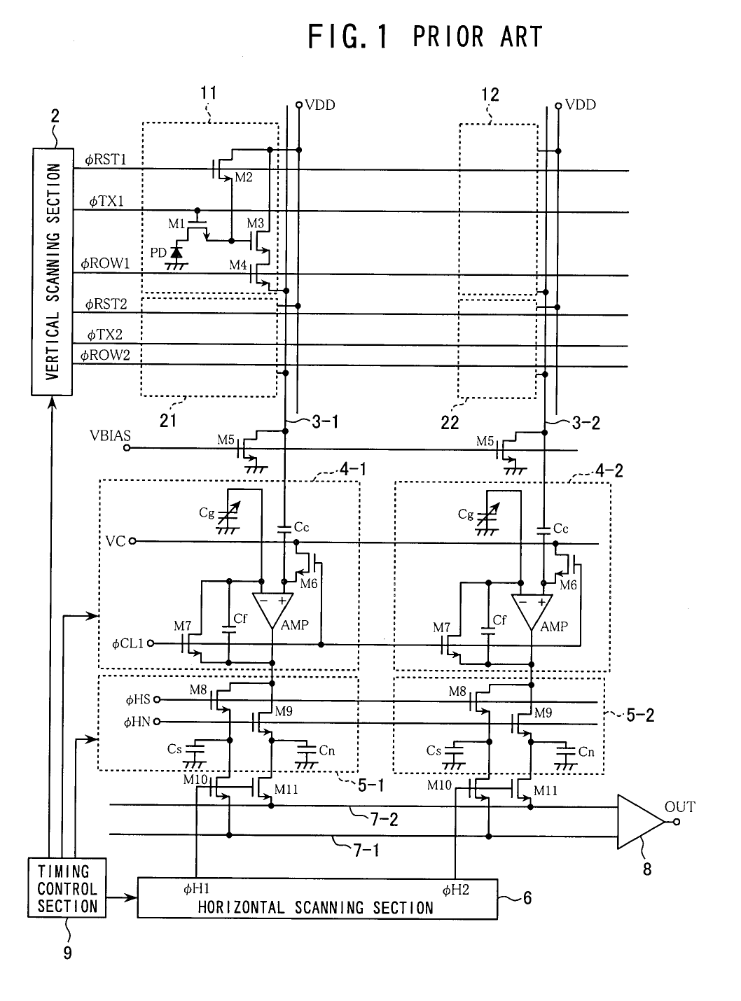

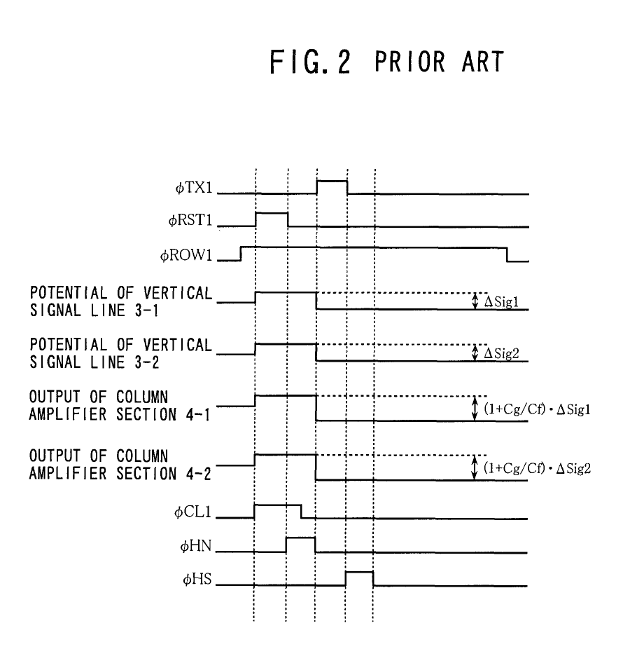

### DETAILED DESCRIPTION OF THE PREFERRED EMBODIMENTS

By referring to the accompanying drawings, embodiments of a solid-state imaging apparatus of the invention are described. Herein, any components similar to those described in the background section are each provided with the same reference numeral.

### Embodiment 1

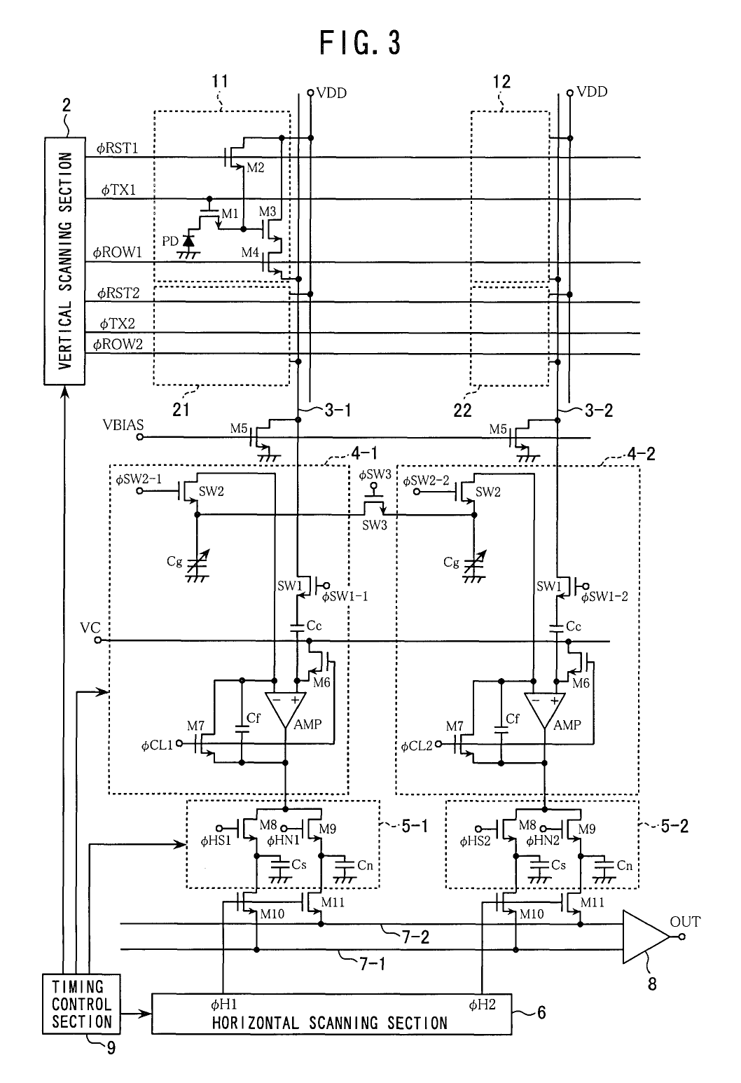

First of all, a first embodiment is described. FIG. 3 is a diagram showing the circuit configuration of a solid-state imaging apparatus of a first embodiment of the invention, showing a part thereof by blocks. The solid-state imaging apparatus of the first embodiment is configured to include the pixels 11, 12, 21, and 22, the vertical scanning section 2, the vertical signal lines 3-1 and 3-2, the bias transistors M5, the column amplification sections 4-1 and 4-2, the vertical signal lines 3-1 and 3-2, the noise suppression sections 5-1 and 5-2, the column-selection transistors M10 and M11, the horizontal scanning section 6, the output amplifier 8, and the timing control section 9. The pixels 11, 12, 21, and 22 are arranged in a matrix (2-by-2 matrix in FIG. 3 example), and the vertical scanning section 2 serves to provide read pulses to the pixels 11, 12, 21, and 22 The vertical signal lines 3-1 and 3-2 serve to transmit signals outputted from the pixels 11, 12, 21, and 22, and the bias transistors M5 respectively provide a constant current to the vertical signal lines 3-1 and 3-2. The column amplification sections 4-1 and 4-2 respectively serve to amplify the potentials of the vertical signal lines 3-1 and 3-2. The noise suppression sections 5-1 and 5-2 are those for respectively eliminating any noise included in the outputs from the column amplification sections 4-1 and 4-2 The column-selection transistors M10 and M11 are those for outputting signals selectively to horizontal signal lines 7-1 and 7-2 from the noise suppression sections 5-1 and 5-2, respectively. The horizontal scanning section 6 serves to provide pulses to each of the column-selection transistors M10 and M11 The output amplifier 8 serves to amplify, before output, the signals from the horizontal signal lines 7-1 and 7-2 The timing control section 9 provides a control signal to each of the components, i.e., the vertical scanning section 2, the column amplification sections 4-1 and 4-2, the noise suppression sections 5-1 and 5-2, and the horizontal scanning section 6.

The pixels 11, 12, 21, and 22 are each configured to include the photodiode PD, the transfer transistor M1, the amplification transistor M3, the reset transistor M2, and the row-selection transistor M4. The photodiode PD serves to convert an incident light into an electric signal. The transfer transistor M1 serves to transfer the electric signal accumulated in the photodiode PD, and the amplification transistor M3 serves to amplify the electric signal provided through transfer. The reset transistor M2 serves to reset the potential of a gate electrode of the amplification transistor M3 or others, and the row-selection transistor M4 serves to selectively output a signal being the amplification result of the electric signal. The gates of these transistors, ie, the transfer transistor M1, the reset transistor M2, and the row-selection transistor M4, are respectively provided with various pulses from the vertical scanning section 2 on a row basis. Such pulses include the transfer pulses φTX1 and φTX2, the reset pulses φRST1 and φRST2, and the row-selection pulses φROW1 and φROW2. The drains of the transistors, i.e., the reset transistor M2, and the amplification transistor M3, are each coupled with the pixel power supply VDD.

The column amplification sections 4-1 and 4-2 are each of a non-inverting amplifier type, and are each configured to include a coupling switch SW1, the gain amplifier AMP, the clamp capacitor Cc, the clamp transistor M6, the feedback capacitor Cf, the amplifier reset transistor M7, and the amplifier capacitor Cg. The coupling switch SW1 in the column amplification section 4-1 serves to couple a first input terminal thereof and the vertical signal line 3-1, and the coupling switch SW1 in the column amplifier section 4-2 serves to couple a first input terminal thereof and the vertical signal line 3-2. The gain amplifier AMP is provided for amplifying the signals outputted from the corresponding pixels 11 and 21, or 12 and 22. The clamp capacitor Cc is coupled between an non-inverting input terminal of the gain amplifier AMP and the coupling switch SW1 to clamp the output from the corresponding pixels 11 and 21, or 12 and 22 at a clamp potential VC. The clamp transistor M6 serves to supply the clamp potential VC to the non-inverting input terminal of the gain amplifier AMP The feedback capacitor Cf and the amplifier reset transistor M7 are those coupled between the inverting input terminal and an output terminal of the gain amplifier AMP. The amplifier capacitor Cg is coupled between the inverting input terminal of the gain amplifier AMP, i.e., a second input terminal of the corresponding column amplification section 4-1 or 4-2 and the ground potential via a coupling switch SW2, and is in charge of setting of an amplification rate for the corresponding column amplification section 4-1 or 4-2. The gates of the transistors in the column amplification section 4-1 in the first column, i.e., the clamp transistor M6 and the amplifier reset transistor M7, are so designed as to receive a clamp pulse φCL1, and the gates of such transistors in the column amplification section 4-2 in the second column are so designed as to receive a clamp pulse φCL2.

The coupling switch SW1 in the column amplification section 4-1 in the first column is provided with a pulse φSW1-1, and the coupling switch SW1 in the column amplification section 4-2 in the second column is provided with a pulse φSW1-2. Moreover, the coupling switch SW2 in the column amplifier section 4-1 in the first column is provided with a pulse φSW2-1, and the coupling switch SW2 in the column amplification section 4-2 in the second column is provided with a pulse φSW2-2 A coupling switch SW3 is also provided for coupling together the amplifier capacitor Cg of the column amplification section 4-1 in the first column and the amplifier capacitor Cg of the column amplification section 4-2 in the second column, and the coupling switch SW3 is provided with a control pulse φSW3.

The noise suppression sections 5-1 and 5-2 are each configured to include a reset sample capacitor Cn, a reset sample transistor M9, a signal sample capacitor Cs, and a signal sample transistor M8. The reset sample capacitor Cn holds the reset potential from the corresponding column amplification section 4-1 or 4-2. The reset sample transistor M9 establishes a coupling between the output from the corresponding column amplification section 4-1 or 4-2 and the reset sample capacitor Cn. The signal sample capacitor Cs holds the signal potential from the corresponding column amplification section 4-1 or 4-2 The signal sample transistor M8 establishes a coupling between the output from the corresponding column amplification section 4-1 or 4-2 and the signal sample capacitor Cs. The gate of the signal sample transistor M8 in the noise suppression section 5-1 in the first column is so designed as to receive a signal sample pulse φHS1, and the gate of the reset sample transistor M9 is so designed as to receive a reset sample pulse φHN1. Moreover, the gate of the signal sample transistor M8 in the noise suppression section 5-2 in the second column is so designed as to receive a signal sample pulse φHS2, and the gate of the reset sample transistor M9 is so designed as to receive a reset sample pulse φHN2.

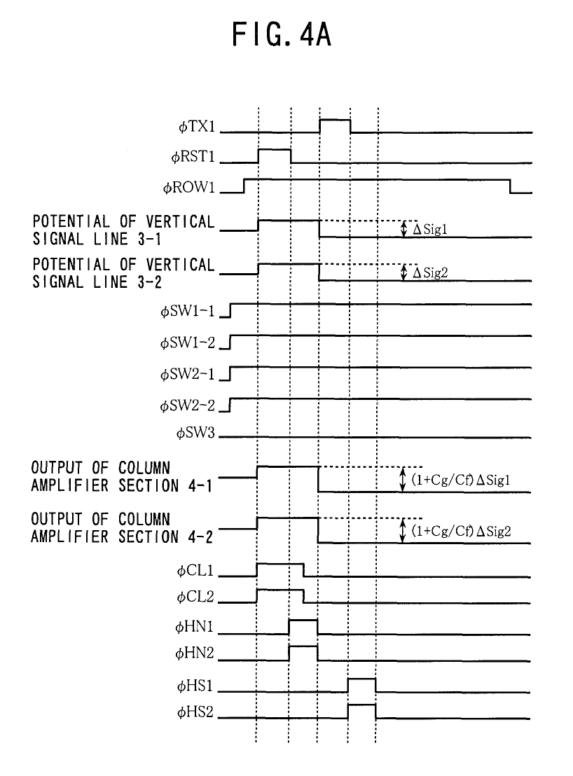

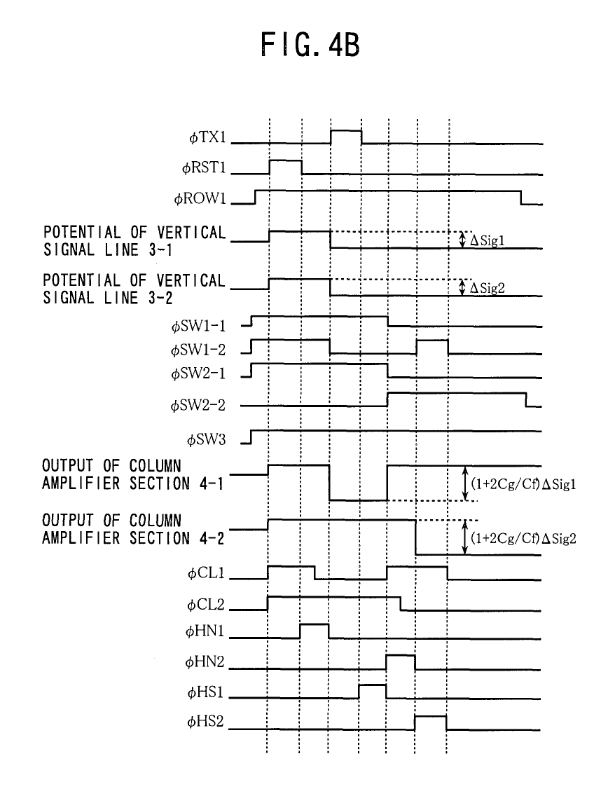

FIGS. 4A and 4B are each a timing chart for illustrating the operation of the solid-state imaging apparatus of FIG. 3 in the first embodiment of the invention. Described first is the operation in a normal read mode based on the timing chart of FIG. 4A. In this operation mode, the coupling switches SW1 and SW2 are both set in the state of ON, and the coupling switch SW3 is set in the state of OFF. First of all, the vertical scanning section 2 enables the read operation of the pixels 11 and 12 in the first row, and the row-selection pulse φROW1 is set to the H level so that the row-selection transistors M4 are changed their states to ON. The outputs of the amplification transistors M3 are then respectively read to the vertical signal lines 3-1 and 3-2 The reset pulse φRST1 is then set to the H level so that the reset transistors M2 are changed their states to ON This accordingly resets the gates of the amplification transistors M3 at the reset potential, and the outputs of the pixels 11 and 12 related to the reset potential are respectively read to the vertical signal lines 3-1 and 3-2. At this time, the clamp pulses φCL1 and φCL2 are both set to the H level, and the amplifier reset transistors M7 of the column amplification sections 4-1 and 4-2 are both changed their states to ON, thereby resetting the column amplification sections 4-1 and 4-2. At the same time, the clamp transistors M6 are changed their states to ON, and the non-inverting input terminal of each of the gain amplifiers AMP is clamped at the clamp potential VC.

Next, after the reset pulse φRST1 is set to the L level, the clamp pulses φCL1 and φCL2 are both set to the L level, and this is the end of the clamping. Moreover, when the reset pulse φRST1 is set to the L level, the reset sample pulses φHN1 and φHN2 are both set to the H level, thereby reading the reset signals of the column amplification sections 4-1 and 4-2 to their each reset sample capacitor Cn. The reset sample pulses φHN1 and φHN2 are then set to the L level, thereby maintaining the reset signals of the column amplification sections 4-1 and 4-2 in their each reset sample capacitor Cn. Next, the transfer pulse φTX1 is set to the H level, and the transfer transistors M1 are changed their states to ON, thereby transferring an electric signal being the conversion result of an optical signal generated in the photodiode PD to the gates of the amplification transistors M3.

The vertical signal lines 3-1 and 3-2 are thus each provided with a signal being the amplification result of the electric signal, which is the conversion result of the optical signal. Then in the gain amplifiers AMP of the column amplification sections 4-1 and 4-2, their non-inverting input terminals respectively show changes of the potential of ΔSig1 and ΔSig2 by the clamp capacitor Cc from the reset potential values of the pixels 11 and 12 due to the electric signal being the conversion result of the optical signal. At this time, the outputs of the column amplification sections 4-1 and 4-2 show changes of (1+Cg/Cf) ΔSig1, and (1+Cg/Cf)ΔSig2 with respect to the reset signals of the column amplification sections 4-1 and 4-2, respectively. Next, after the transfer pulse φTX1 is set to the L level, the signal sample pulses φHS1 and φHS2 are both set to the H level, thereby reading the read signals from the column amplification sections 4-1 and 4-2 to their each signal sample capacitor Cs The signal sample pulses φHS1 and φHS2 are then set to the L level, thereby maintaining the read signals from the column amplification sections 4-1 and 4-2 in their each signal sample capacitor Cs.

Lastly, the signals maintained in the signal sample capacitors Cs and the reset sample capacitors Cn are read respectively to the horizontal signal lines 7-1 and 7-2 in a sequential manner by the horizontal scanning section 6, and the read results are differentiated by the output amplifier 8 for output. The reset signals and the read signals of the column amplificationr sections 4-1 and 4-2 each include offset noise caused by the column amplification sections 4-1 and 4-2. However, the differential operation by the output amplifier 8 enables to extract only the electric signal ΔSig being the conversion result of the optical signal generated in the photodiode PD Moreover, the electric signal ΔSig is multiplied by (1+Cg/Cf) in each of the column amplification sections 4-1 and 4-2, thereby being able to reduce any noise possibly caused by the components subsequent to the column amplification sections 4-1 and 4-2.

As such, in the general read operation mode of FIG. 4A, the operation is similar to that in the previous MOS-type image sensor.

Described next is a read operation of gain boost with an implementation of the higher amplification rate based on the timing chart of FIG. 4B. In this operation mode, the coupling switch SW3 is set in the state of ON, and the coupling switches SW1 and SW2 are subjected to pulse control during reading of rows First of all, the vertical scanning section 2 enables the read operation of the pixels 11 and 12 in the first row, and the row-selection pulse φROW1 is set to the H level so that the row-selection transistors M4 are changed their states to ON. The outputs of the amplification transistors M3 are then respectively read to the vertical signal lines 3-1 and 3-2. The reset pulse φRST1 is then set to the H level so that the reset transistors M2 are changed their states to ON This accordingly resets the gates of the amplifier transistors M3 at the reset potential, and the outputs of the pixels 11 and 12 related to the reset potential are respectively read to the vertical signal lines 3-1 and 3-2.

At this time, the coupling control pulses φSW1-1 and φSW1-2 are both set to the H level, and the coupling switches SW1 in the first and second columns are both set in the state of ON, thereby keeping the states of coupling between the vertical signal lines 3-1 and 3-2 and the column amplification sections 4-1 and 4-2, respectively Moreover, the coupling control pulse φSW2-1 is set to the H level, and the coupling control pulse φSW2-2 is set to the L level, whereby the coupling switch SW2 in the first column is changed its state to ON, and the coupling switch SW2 in the second column is changed its state to OFF. In this manner, the amplifier capacitor Cg of the column amplification section 4-1 in the first column is coupled in parallel to the amplifier capacitor Cg of the column amplification section 4-2 in the second column, and the amplifier capacitor Cg of the column amplification section 4-2 in the second column is electrically decoupled from the column amplification section 4-2 in the second column. Thereafter, the clamp pulses φCL1 and φCL2 are both set to the H level, and the amplifier reset transistors M7 of the column amplification sections 4-1 and 4-2 are both changed their states to ON, thereby resetting the column amplification sections 4-1 and 4-2. At the same time, the clamp transistors M6 are both changed their states to ON, thereby clamping the non-inverting input terminals of the gain amplifiers AMP each at the clamp potential VC.

Next, after the reset pulse φRST1 is set to the L level, the clamp pulse φCL1 is set to the L level, and this is the end of the clamping. Moreover, when the reset pulse φRST1 is set to the L level, the reset sample pulse φHN1 is set to the H level, thereby reading the reset signal of the column amplification section 4-1 in the first column to the reset sample capacitor Cn of the noise suppression section 5-1 in the first column. The reset sample pulse φHN1 is then set to the L level, thereby maintaining the reset signal in the reset sample capacitor Cn. At this time, the clamp pulse φCL2 is set to the H level, and the column amplification section 4-2 in the second column is remained in the state of resetting. Next, the transfer pulse φTX1 is set to the H level, and the transfer transistors M1 are changed their states to ON, thereby transferring an electric signal being the conversion result of an optical signal generated in the photodiode PD to the gates of the amplifier transistors M3.

In this manner, the vertical signal lines 3-1 and 3-2 are each provided with a signal being the amplification result of the electric signal, which is the conversion result of the optical signal.

At this time, the coupling control pulse φSW1-1 is set to the H level, and the coupling control pulse φSW1-2 is set to the L level, whereby the coupling switch SW1 in the first column is set in the state of ON, and the coupling switch SW1 in the second column is set in the state of OFF.

This accordingly keeps the state of coupling between the vertical signal line 3-1 and the column amplification section 4-1 both in the first column, and keeps the state of decoupling between the vertical signal line 3-2 and the column amplification section 4-2 both in the second column. The non-inverting input terminal of the gain amplifier AMP of the column amplification section 4-1 in the first column shows a change of ΔSig1 by the clamp capacitor Cc from the reset potential value of the pixel 11 due to the electric signal being the conversion result of the optical signal. At this time, the output of the column amplification section 4-1 in the first column shows a change of (1+2Cg/Cf) ΔSig1 with respect to the reset signal of the column amplification section 4-1. Next, after the transfer pulse φTX1 is set to the L level, the signal sample pulse φHS1 is set to the H level, thereby reading the read signal from the column amplification section 4-1 in the first column to the signal sample capacitor Cs of the noise suppression section 5-1 in the first column The signal sample pulse φHS1 is then set to the L level, thereby maintaining the read signal in the signal sample capacitor Cs

Thereafter, the coupling control pulse φSW2-1 is set to the L level, and the coupling control pulse φSW2-2 is set to the H level, whereby the coupling switch SW2 in the first column is changed its state to OFF, and the coupling switch SW2 in the second column is changed its state to ON. In this manner, the amplifier capacitor Cg of the column amplification section 4-2 in the second column is coupled in parallel with the amplifier capacitor Cg of the column amplification section 4-1 in the first column, and the amplifier capacitor Cg of the column amplification section 4-1 in the first column is electrically decoupled from the column amplification section 4-1 in the first column The clamp pulse φCL2 is then set to the L level, and this is the end of the clamping. The reset sample pulse φHN2 is then set to the H level, thereby reading the reset signal of the column amplification section 4-2 in the second column to the reset sample capacitor Cn of the noise suppression section 5-2 in the second column The reset sample pulse φHN2 is then set to the L level, thereby maintaining the reset signal in the reset sample capacitor Cn.

Next, the coupling control pulse φSW1-2 is set to the H level, and the coupling switch SW1 in the second column is set in the state of ON, thereby establishing a coupling between the vertical signal line 3-2 and the column amplification section 4-2 both in the second column As a result, the non-inverting input terminal of the gain amplifier AMP of the column amplification section 4-2 in the second column shows a change of ΔSig2 by the clamp capacitor Cc from the reset potential value of the pixel 12 due to the electric signal being the conversion result of the optical signal. At this time, the output of the column amplification section 4-2 in the second column shows a change of (1+2Cg/Cf)ΔSig2 with respect to the reset signal of the column amplification section 4-2 Next, after the signal sample pulse φHS2 is set to the H level, thereby reading the read signal from the column amplification section 4-2 in the second column to the signal sample capacitor Cs of the noise suppression section 5-2 in the second column. The signal sample pulse φHS2 is then set to the L level, thereby maintaining the read signal in the signal sample capacitor Cs.

Lastly, the signals maintained in the signal sample capacitors Cs and the reset sample capacitors Cn are read respectively to the horizontal signal lines 7-1 and 7-2 in a sequential manner by the horizontal scanning section 6, and the read results are differentiated by the output amplifier 8 for output. The reset signals and the read signals of the column amplification sections 4-1 and 4-2 each include offset noise caused by the column amplification sections 4-1 and 4-2. However, the differential operation by the output amplifier 8 enables to extract only the electric signal ΔSig being the conversion result of the optical signal generated in the photodiode PD. Moreover, with the parallel coupling between the amplifier capacitors Cg of the column amplification sections 4-1 and 4-2 adjacent to each other, the signal ΔSig can be multiplied by (1+2Cg/Cf) so that the resulting amplification rate can be high, and any noise possibly caused by the components subsequent to the column amplification sections 4-1 and 4-2 can be favorably reduced.

As such, in this embodiment, in the column amplification sections 4-1 and 4-2 of a non-inverting amplifier type, by coupling in parallel the amplifier capacitors Cg of the column amplification sections 4-1 and 4-2 adjacent to each other, the amplification rate can be higher than before in the column amplification sections 4-1 and 4-2 with no more need for additional capacitor increase.

This thus favorably enables to reduce to a further degree any influence of the noise to be caused in the components subsequent to the column amplification sections 4-1 and 4-2 without causing the increase of the chip area.

### Embodiment 2

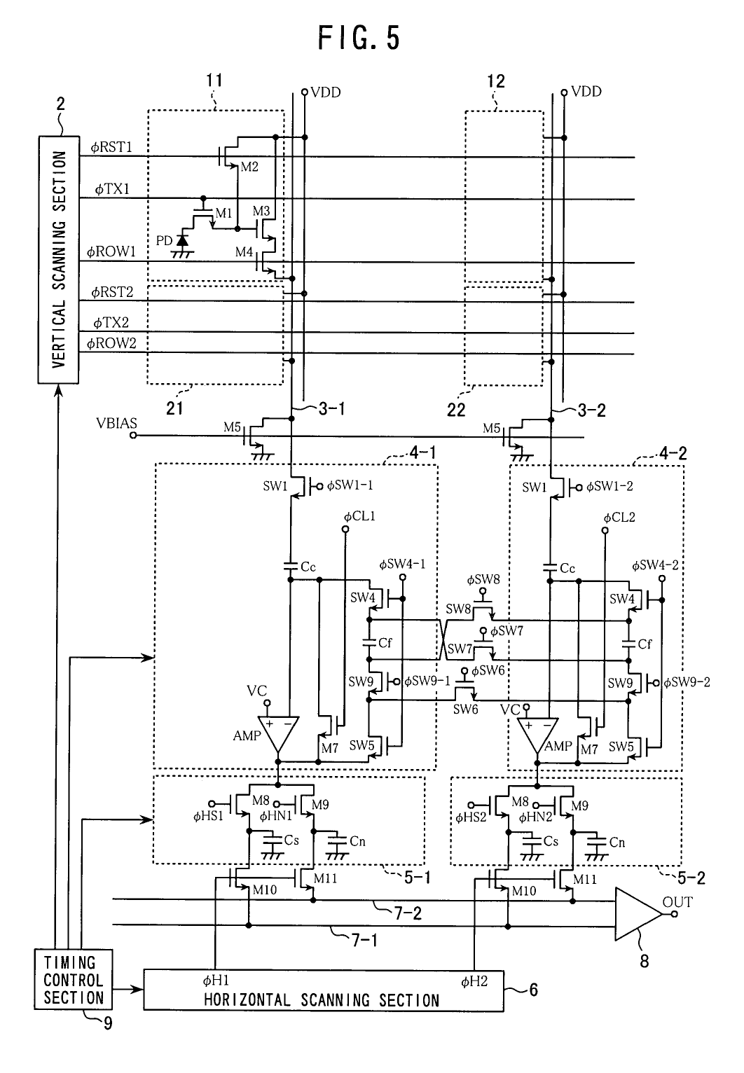

Described next is a second embodiment. FIG. 5 is a diagram showing the circuit configuration of a solid-state imaging apparatus of a second embodiment of the invention, showing a part thereof by blocks. Compared with the first embodiment of FIG. 3, the column amplification sections 4-1 and 4-2 are different in configuration, but the remaining is the same, and any component same as that in the first embodiment of FIG. 3 is provided with the same reference numeral. The column amplification sections 4-1 and 4-2 in the second embodiment of FIG. 5 are each of an inverting amplifier type, and are each configured to include the coupling switch SW1, the gain amplifier AMP, the clamp capacitor Cc, the feedback capacitor Cf, and the amplifier reset transistor M7 The coupling switch SW1 in the column amplification section 4-1 serves to couple a first input terminal thereof and the vertical signal line 3-1, and the coupling switch SW1 in the column amplification section 4-2 serves to couple a first input terminal thereof and the vertical signal line 3-2. The gain amplifier AMP is provided for amplifying the signals outputted from the corresponding pixels 11 and 21, or 12 and 22. The clamp capacitor Cc serves to clamp the output from the corresponding pixels 11 and 21, or 12 and 22. The feedback capacitor Cf is coupled between the inverting input terminal and an output terminal of the gain amplifier AMP via coupling switches SW4, SW5, and SW9, and is in charge of setting the amplification rate of the corresponding column amplification section 4-1 or 4-2 The inverting input terminal here is a second input terminal of the corresponding column amplification section 4-1 or 4-2. The amplifier reset transistor M7 is coupled between the inverting input terminal and the output terminal of the gain amplifier AMP.

The non-inverting input terminal of the gain amplifier AMP is provided with the clamp potential VC, and the gate of the amplifier reset transistor M7 of the column amplification section 4-1 in the first column is provided with a clamp pulse φCL1 The gate of the amplifier reset transistor M7 of the column amplification section 4-2 in the second column is provided with a clamp pulse φCL2. Coupling switches SW6, SW7, and SW8 are also provided for coupling in series the feedback capacitor Cf of the column amplification section 4-1 in the first column to the feedback capacitor Cf of the column amplification section 4-2 in the second column.

The coupling switch SW1 of the column amplification section 4-1 in the first column is provided with the coupling control pulse φSW1-1, and the coupling switch SW1 of the column amplification section 4-2 in the second column is provided with the coupling control pulse φSW1-2.

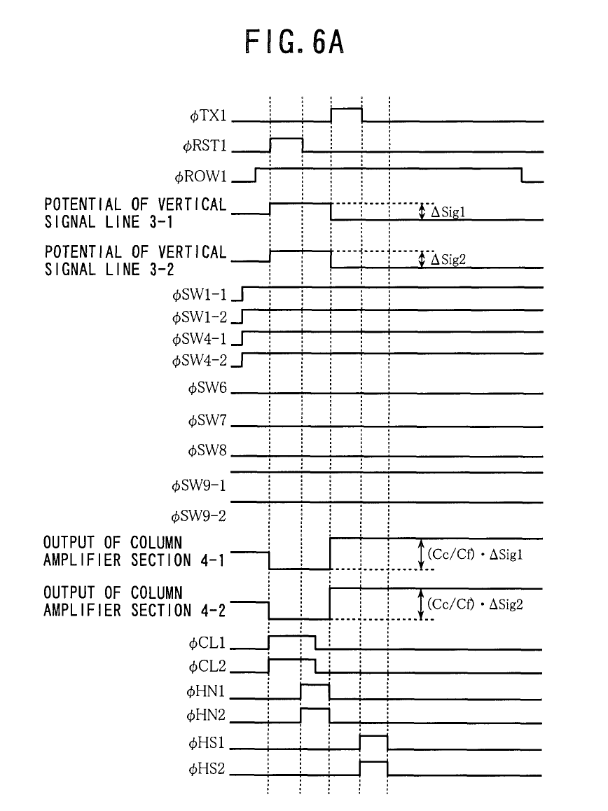

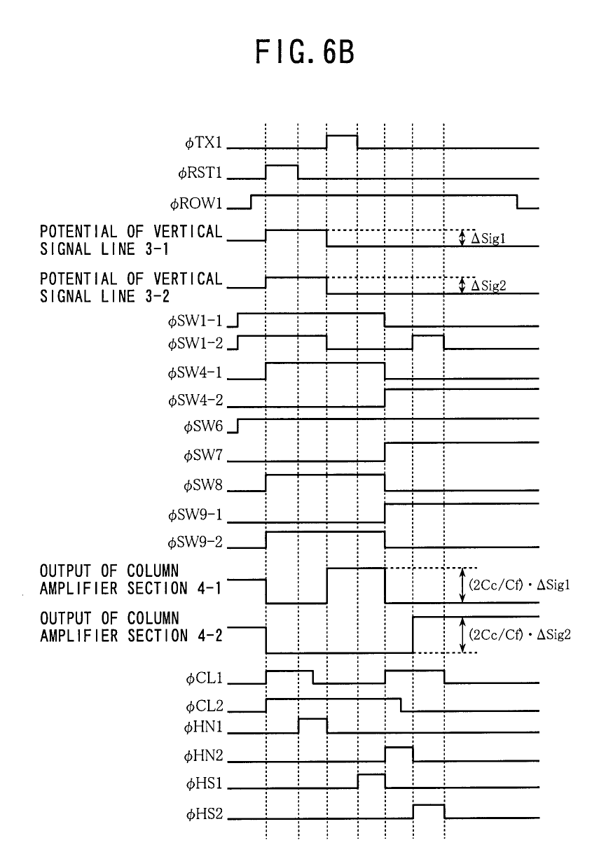

The coupling switches SW4 and SW5 of the column amplification section 4-1 in the first column are each provided with a coupling control pulse φSW4-1, and the coupling switches SW4 and SW5 in the column amplification section 4-2 in the second column are each provided with a coupling control pulse φSW4-2. The coupling switch SW9 of the column amplification section 4-1 in the first column is provided with a coupling control pulse φSW9-1, and the coupling switch SW9 of the column amplification section 4-2 in the second column is provided with a coupling control pulse φSW9-2. The coupling switches SW6, SW7, and SW8 are respectively provided with coupling control pulses φSW6, φSW7, and φSW8 FIGS. 6A and 6B are each a timing chart for illustrating the operation of the apparatus of FIG. 5 in the second embodiment. Described first is the operation in the normal read mode based on the timing chart of FIG. 6A. In this operation mode, the coupling switches SW1, SW4, SW5, and SW9 are all set in the state of ON, and the coupling switches SW6, SW7, and SW8 are all set in the state of OFF.

First of all, the vertical scanning section 2 enables the read operation of the pixels 11 and 12 in the first row, and the row-selection pulse φROW1 is set to the H level so that the row-selection transistors M4 are changed their states to ON This accordingly enables provision of the outputs of the amplification transistors M3 to the vertical signal lines 3-1 and 3-2, respectively. The reset pulse φRST1 is then set to the H level so that the reset transistors M2 are changed their states to ON. This accordingly resets the gates of the amplification transistors M3 at the reset potential, and the outputs of the pixels 11 and 12 related to the reset potential are respectively read to the vertical signal lines 3-1 and 3-2.

At this time, the clamp pulses φCL1 and φCL2 are both set to the H level, and the amplifier reset transistors M7 of the column amplification sections 4-1 and 4-2 are both changed their states to ON, thereby resetting the column amplification sections 4-1 and 4-2. Next, the reset pulse φRST1 is set to the L level, and the clamp pulses φCL1 and φCL2 are set to the L level, thereby cancelling the resetting of the column amplification sections 4-1 and 4-2.

Moreover, when the reset pulse φRST1 is set to the L level as such, the reset sample pulses φHN1 and φHN2 are both set to the H level, thereby reading the reset signals of the column amplification sections 4-1 and 4-2 to the reset sample capacitor Cn. The reset sample pulses φHN1 and φHN2 are then set to the L level, thereby maintaining the reset signals in their each reset sample capacitor Cn.

Next, the transfer pulse φTX1 is set to the H level, thereby transferring an electric signal being the conversion result of an optical signal generated in the photodiode PD to the gates of the amplifier transistors M3.

The vertical signal lines 3-1 and 3-2 are each provided with a signal being the amplification result of the electric signal, which is the conversion result of the optical signal. The outputs of the column amplification sections 4-1 and 4-2 show changes of (Cc/Cf)ΔSig1, and (Cc/Cf)ΔSig2 with respect to the reset signals of the column amplification sections 4-1 and 4-2, respectively. Next, after the transfer pulse φTX1 is set to the L level, the signal sample pulses φHS1 and φHS2 are both set to the H level, thereby reading the read signals from the column amplification sections 4-1 and 4-2 to their each signal sample capacitor Cs. The signal sample pulses φHS1 and φHS2 are then set to the L level, thereby maintaining the read signals in their each signal capacitor Cs.

Lastly, the signals maintained in the signal sample capacitors Cs and the reset sample capacitors Cn are read respectively to the horizontal signal lines 7-1 and 7-2 in a sequential manner by the horizontal scanning section 6, and the read results are differentiated by the output amplifier 8 for output. The reset signals and the read signals of the column amplification sections 4-1 and 4-2 each include offset noise caused by the column amplification sections 4-1 and 4-2. However, the differential operation by the output amplifier 8 enables to extract only the electric signal ΔSig being the conversion result of the optical signal generated in the photodiode PD Moreover, the electric signal ΔSig is multiplied by (Cc/Cf) in each of the column amplification sections 4-1 and 4-2, thereby being able to reduce any noise possibly caused by the components subsequent to the column amplification sections 4-1 and 4-2.

Based on the timing chart of FIG. 6B, described next is a read operation of gain boost with an implementation of the higher amplification rate. In this operation mode, the coupling switch SW6 is set in the state of ON, and the coupling switches SW1, SW4, SW5, SW7, and SW8 are subjected to pulse control during reading of rows. First of all, the vertical scanning section 2 enables the read operation of the pixels 11 and 12 in the first row, and the row-selection pulse φROW1 is set to the H level so that the row-selection transistors M4 are changed their states to ON The outputs of the amplifier transistors M3 are then respectively read to the vertical signal lines 3-1 and 3-2.

The reset pulse φRST1 is then set to the H level so that the reset transistors M2 are changed their states to ON. This accordingly resets the gates of the amplifier transistors M3 at the reset potential, and the outputs of the pixels 11 and 12 related to the reset potential are respectively read to the vertical signal lines 3-1 and 3-2.

At this time, the coupling control pulses φSW1-1 and φSW1-2 are both set to the H level, and the coupling switches SW1 in the first and second columns are both set in the state of ON, thereby keeping the states of coupling between the vertical signal lines 3-1 and 3-2 and the column amplification sections 4-1 and 4-2, respectively. Moreover, the coupling control pulse φSW4-1 is set to the H level, the coupling control pulse φSW4-2 is set to the L level, the coupling control pulse φSW9-1 is set to the L level, and the coupling control pulse φSW9-2 is set to the H level, whereby the coupling switches SW4 and SW5 of the column amplification section 4-1 in the first column are changed their states to ON, and the coupling switches SW4 and SW5 of the column amplification section 4-2 in the second column are changed their states to OFF. Moreover, the coupling switch SW9 of the column amplification section 4-1 in the first column is changed its state to OFF, and the coupling switch SW9 of the column amplification section 4-2 in the second column is changed its state to ON. Also, the coupling control pulse φSW6 is set to the H level, the coupling control pulse φSW7 is set to the L level, and the coupling control pulse φSW8 is set to the H level, whereby the feedback capacitor Cf of the column amplification section 4-2 in the second column is coupled in series to the feedback capacitor Cf of the column amplification section 4-1 in the first column, and the feedback capacitor Cf of the column amplification section 4-2 in the second column is electrically decoupled from the column amplification section 4-2 in the second column The clamp pulses φCL1 and φCL2 are then both set to the H level, and the amplifier reset transistors M7 of the column amplification sections 4-1 and 4-2 are changed their states to ON, thereby resetting the column amplification sections 4-1 and 4-2.

Next, after the reset pulse φRST1 is set to the L level, the clamp pulse φCL1 is set to the L level, thereby cancelling the resetting of the column amplification section 4-1 in the first column. When the reset pulse φRST1 is set to the L level as such, the reset sample pulse φHN1 is set to the H level, thereby reading the reset signal of the column amplification section 4-1 in the first column to the reset sample capacitor Cn of the noise suppression section 5-1 in the first column. The reset sample pulse φHN1 is then set to the L level, thereby maintaining the reset signal in the reset sample capacitor Cn At this time, the clamp pulse φCL2 is set to the H level, and the column amplification section 4-2 in the second column is remained in the state of resetting.

Next, the transfer pulse φTX1 is set to the H level, and the transfer transistors M1 are changed their states to ON, thereby transferring an electric signal being the conversion result of an optical signal generated in the photodiode PD to the gates of the amplification transistors M3. In this manner, the vertical signal lines 3-1 and 3-2 are each provided with a signal being the amplification result of the electric signal, which is the conversion result of the optical signal. At this time, the coupling control pulse φSW1-1 is set to the H level, and the coupling control pulse φSW1-2 is set to the L level, whereby the coupling switch SW1 in the first column is set in the state of ON, and the coupling switch SW1 in the second column is set in the state of OFF This accordingly keeps the state of coupling between the vertical signal line 3-1 and the column amplification section 4-1 both in the first column, and keeps the state of decoupling between the vertical signal line 3-2 and the column amplification section 4-2 both in the second column At this time, the output of the column amplification section 4-1 in the first column shows a change of (2Cc/Cf)ΔSig1 with respect to the reset signal of the column amplification section 4-1 Next, after the transfer pulse φTX1 is set to the L level, the signal sample pulse φHS1 is set to the H level, thereby reading the read signal from the column amplification section 4-1 in the first column to the signal sample capacitor Cs of the noise suppression section 5-1 in the first column. The signal sample pulse φHS1 is then set to the L level, thereby maintaining the read signal in the signal sample capacitor Cs.

Thereafter, the coupling control pulse φSW4-1 is set to the L level, the coupling control pulse φSW4-2 is set to the H level, the coupling control pulse φSW9-1 is set to the H level, and the coupling control pulse φSW9-2 is set to the L level, whereby the coupling switches SW4 and SW5 of the column amplification section 4-1 in the first column are changed their states to OFF, and the coupling switches SW4 and SW5 of the column amplification section 4-2 in the second column are changed their states to ON. Moreover, the coupling switch SW9 of the column amplification section 4-1 in the first column is changed its state to ON, and the coupling switch SW9 of the column amplification section 4-2 in the second column is changed its state to OFF. Also, the coupling control pulse φSW6 is set to the H level, the coupling control pulse φSW7 is set to the H level, and the coupling control pulse φSW8 is set to the L level, whereby the feedback capacitor Cf of the column amplification section 4-2 in the second column is coupled in series with the feedback capacitor Cf of the column amplification section 4-1 in the first column, and the feedback capacitor Cf of the column amplification section 4-1 in the first column is electrically decoupled from the column amplification section 4-1 in the first column. The clamp pulse φCL2 is then set to the L level, thereby cancelling the resetting of the column amplification section 4-2 in the second column. The reset sample pulse φHN2 is then set to the H level, thereby reading the reset signal of the column amplification section 4-2 in the second column to the reset sample capacitor Cn of the noise suppression section 5-2 in the second column The reset sample pulse φHN2 is then set to the L level, thereby maintaining the reset signal in the reset sample capacitor Cn.

Next, the coupling control pulse φSW1-2 is set to the H level, and the coupling switch SW1 in the second column is set in the state of ON, thereby keeping the state of coupling between the vertical signal line 3-2 and the column amplification section 4-2 both in the second column. As a result, the output of the column amplification section 4-2 in the second column shows a change of (2Cc/Cf)ΔSig2 with respect to the reset signal of the column amplification section 4-2. The signal sample pulse φHS2 is then set to the H level, thereby reading the read signal from the column amplification section 4-2 to the signal sample capacitor Cs of the noise suppression section 5-2 in the second column. The signal sample pulse φHS2 is then set to the L level, thereby maintaining the read signal in the signal sample capacitor Cs.

Lastly, the signals maintained in the signal sample capacitors Cs and the reset sample capacitors Cn are read respectively to the horizontal signal lines 7-1 and 7-2 in a sequential manner by the horizontal scanning section 6, and the read results are differentiated by the output amplifier 8 for output. The reset signals and the read signals of the column amplification sections 4-1 and 4-2 each include offset noise caused by the column amplification sections 4-1 and 4-2. However, the differential operation by the output amplifier 8 enables to extract only the electric signal ΔSig being the conversion result of the optical signal generated in the photodiode PD. Moreover, with the series coupling between the feedback capacitors Cf of the column amplification sections 4-1 and 4-2 adjacent to each other, the signal ΔSig can be multiplied by (2Cc/Cf) so that the resulting amplification rate can be high, and any noise possibly caused by the components subsequent to the column amplification sections 4-1 and 4-2 can be favorably reduced.

As such, in this embodiment, in the column amplification sections 4-1 and 4-2 of an inverting amplifier type, by coupling in series the feedback capacitors Cf of the column amplification sections 4-1 and 4-2 adjacent to each other, the amplification rate can be higher than before in the column amplification sections 4-1 and 4-2 with no more need for additional capacitor increase.

This thus favorably enables to reduce to a further degree any influence of the noise to be caused in the components subsequent to the column amplification sections 4-1 and 4-2 without causing the increase of the chip area.

Although the first and second embodiments are described above, the invention is surely not restrictive thereto, and alternatively, the load for use to set an amplification rate in the column amplification sections may be configured by a resistor, for example. Moreover, exemplified in the first and second embodiments is the case of increasing the amplification rate by load coupling in parallel or in series in any adjacent two column amplification sections. Alternatively, such adjacent two columns are surely not the only option, and load coupling in parallel or in series in the column amplification sections in the three or more columns may be also possible.

The mode switching between the normal read mode and the gain boost read mode is preferably performed in accordance with any input setting values provided by the setting section about the requirements for imaging such as ISO sensitivity of a camera system, for example.

As described above by way of examples, according to the first aspect of the invention, the load section for use to determine the amplification rate of the column amplification sections is plurally coupled together for use together over a plurality of columns. If this is the configuration, the resulting solid-state imaging apparatus can be provided with the column amplification sections of a high amplification rate with no more need for additional increase of the load section, i.e., no more increase of the chip area. Further, according to the second aspect of the invention, during reading of signals of rows, the load section for use to determine the amplification rate of the column amplification sections is plurally coupled together over a plurality of columns. If this is the configuration, by sequentially changing the state of coupling, the resulting solid-state imaging apparatus can be provided with the column amplification sections of a high amplification rate with no more need for additional increase of the load section. Still further, according to the third aspect of the invention, the capacitor or the resistor for use to determine the amplification rate of the column amplification sections is plurally coupled together over a plurality of columns. If this is the configuration, by changing the state of coupling, the resulting solid-state imaging apparatus can be provided with the column amplification sections of a high amplification rate with no more need for additional increase of the capacitor or the resistor. Still further, according to the fourth aspect of the invention, in a camera system using a solid-state imaging apparatus, the amplification rate of the column amplification sections can be changed in accordance with the requirements for imaging.

What is claimed is:

1. A solid-state imaging apparatus, comprising
a pixel section including a two-dimensional matrix of a plurality of pixels each provided with a photoelectric conversion section, and an amplifier section that amplifies an output of the photoelectric conversion section and outputs a pixel signal,
a column signal line provided on a column basis in the pixel section to receive the pixel signal outputted from the amplification section of each of the pixels,
a column amplification section in which a first input terminal is coupled with an end of each of the column signal lines via a first switch device, and a second input terminal is coupled via a second switch device with a load section that is in charge of setting an amplification rate for use to amplify the pixel signal,
a third switch device that couples together the load section and others in the plurality of various columns, and
a control section that controls coupling and decoupling by the first, second, and third switch devices

2. The solid-state imaging apparatus according to claim 1, wherein the control section couples together the load sections in the plurality of various columns by the third switch device, and with respect to the plurality of various columns coupled together, alternately one by one, performs the coupling between the first and second switch devices in the column amplification section for any of the columns being a pixel signal acquisition target, and the decoupling between the first and second switch devices in the column amplification section for any of the columns being not the pixel signal acquisition target.

3. The solid-state imaging apparatus according to claim 1, wherein the load section is a capacitor or a resistor.

4. The solid-state imaging apparatus according to claim 2, wherein the load section is a capacitor or a resistor.

5. A camera system, comprising
the solid-state imaging apparatus of any one of claims 1 to 4, and
an input section provided to the control section of the solid-state imaging apparatus for setting of a control operation in accordance with imaging requirements.
